(19) United States
(12) Patent Application Publication
(10) Pub. No.: US 2013/0132481 A1
(43) Pub. Date: May 23, 2013

(54) METHOD, APPARATUS AND SYSTEM FOR PROVIDING SOCIAL NETWORK SERVICE USING SOCIAL ACTIVITIES

(71) Applicant: Electronics and Telecommunications Research In, Daejeon-si (KR)

(72) Inventors: Jong Hoon LEE, Daejeon (KR); Jung Tae Kim, Daejeon (KR); Hoon Ki Lee, Daejeon (KR); Eui Hyun Paik, Daejeon (KR)

(73) Assignee: Electronics and Telecommunications Research Institute, Daejeon-si (KR)

(21) Appl. No.: 13/679,226

(22) Filed: Nov. 16, 2012

(30) Foreign Application Priority Data
Nov. 21, 2011 (KR) 10-2011-0121378

(51) Int. Cl. G06F 15/16

(52) U.S. Cl. 709/204

(57) ABSTRACT

A method, an apparatus, and a system for providing a social network service capable of automatically extracting and analyzing social activities of a user to automatically generate a social network applicable to the user are provided. The method for providing a social network service through the user's social activities by automatically recognizing a user's social activities to includes: a profile generating step of generating a user profile based on a user activity profile obtained by collecting and classifying the user's social activities and a user information profile; and a network generating step of generating a social network by analyzing a user interest level based on the user profile. Thus, a multi-aspect social network fitting a time and space can be configured based on collected and analyzed user activities to thus provide social network services.

### CROSS-REFERENCE TO RELATED APPLICATIONS

This application claims the benefit of priority of Korean Patent Application No. 10-2011-0121378 filed on Nov. 21, 2011, all of which are incorporated by reference in their entirety herein.

### BACKGROUND OF THE INVENTION

1. Field of the Invention

The present invention relates to a method, apparatus, and system for establishing a social network between and among users and, more particularly, to a method, apparatus, and system for automatically recognizing users' activities, carriers, locations, and the like, and establishing a space and time-mixed multi-aspect social network reflecting the automatically recognized items, in establishing a social network representing social relationships between and among users. Social activities in the present invention include a behavior of forming a clique (or a group) in a social network, a behavior of authoring contents in a social network, and a search behavior through keywords in a social network, and the present invention relates to a method, an apparatus, and a system for inferring customized recommendation information appropriate for time and space for users and forming various social networks.

2. Related Art

Recently, the rapid prevalence of smart phones and tablet PCs has promoted socialization of Internet services, and user-initiative information is increasingly produced, sharing of information is spread, and technology/service platforms are advancing. In particular, an SNS service providing a service based on social relationships between and among users is being generalized, for which various social network establishing methods are proposed. In a general social network service, information regarding a relationship between users is directly input by users by using an information device or determined through a mutual negotiation between users. This method is based on an explicit relationship request and acceptance, and currently, services are mostly formed by classifying users in the name of such as friends, il-chon (which may be equivalent to a first kin-ship in a sense that how close relationships are), or the like, and in this case, in order to determine a new relationship formed through social activities, a sequential process of requesting and accepting relationship information with a particular user each time is required for users. Currently, various types of social networking services (SNS) through the Internet, such as MySpace and Facebook of the US, LinkedIn, Cyworld, or the like, conduct social networking in this manner, but this method is inconvenient to a user when establishing explicit social relationships of users. Thus, in order to provide social network services of various classifications, a social network group is required to be automatically recommended by a system and a relationship is required to be automatically formed.

Users in social networks have diverse matters of concern and interest and conduct various social activities such as Internet community activities, article search, the use of SNS services, and producing, reading, evaluating particular contents, leaving comments, or the like. Thus, a technique of automatically analyzing such social activities and automatically profiling users' interest to recommend optimized expert groups and knowledge customers is required.

### PRIOR ART DOCUMENT

### Patent Document

(Patent Document 1) Korean Patent Laid Open Publication No. 10-2009-0072575 (Entitled “Apparatus and Method for Recommending User-customized Contents”, Applicant: KT Corporation, Laid-Open Publication Date: Jul. 2, 2009)

### SUMMARY OF THE INVENTION

The present invention provides a method, apparatus, and system for providing a social network service capable of automatically extracting and analyzing social activities of a user to automatically generate a social network applicable to the user.

The present invention also provides a method, apparatus, and a system for providing a social network service capable of automatically profiling social activities of a user to automatically generate a corresponding social network based on time and space.

In an aspect, a method for providing a social network service through the user's social activities by automatically recognizing a user's social activities is provided. The method includes: a profile generating step of generating a user profile based on a user activity profile obtained by collecting and classifying the user's social activities and a user information profile; and a network generating step of generating a social network by analyzing a user interest level based on the user profile.

The network generating step may include: an interest keyword inferring step of inferring location and time interest keyword of the user among keywords stored in the user profile by checking the user profile; and a social network generating step of searching adjacent users having the same interest as that of the user through the interest keyword, and analyzing activity matching degrees through activity profiles of the adjacent users to generate a social network based on an adjacent user having a high association degree.

In the user profile generating step, the user's activity types may be analyzed and classified, a keyword category may be checked in various manners according to the classified user's activity types, an entity name having the highest association degree to the checked keyword category may be selected as a representative keyword, and an activity profile of the user may be generated and updated through the representative keyword.

The network generating step may be performed according to a social network generation request from the user.

In the interest keyword inferring step, keywords stored in the user's activity profile may be checked and attributes of the keywords may be classified to thus infer a location and time interest keyword appropriate for time and space.

The interest keyword inferring step may include: checking the user profile; collecting information regarding a current location of the user; and inferring a location and time interest keyword among the current location information and the keywords stored in the user profile.

In classifying the user's activity types, the user's activity types may be classified into an activity of reading contents, an activity of posting or writing (or leaving) comments, and an activity of evaluating contents.

In another aspect, an apparatus for providing a social network service through the user's social activities by automatically recognizing a user's social activities is provided. The apparatus includes: a profile generating unit configured to generate a user profile based on a user activity profile obtained by collecting and classifying the user's social activities and a user information profile; and a network generating unit configured to generate a social network by analyzing a user interest level based on the user profile.

The network generating unit may include: an interest keyword inferring unit of inferring a location and time interest keyword of the user among keywords stored in the user profile by checking the user profile; and a social network generating unit of searching adjacent users having the same interest as that of the user through the interest keyword, and analyzing activity matching degrees through activity profiles of the adjacent users to generate a social network based on an adjacent user having a high association degree.

The user profile generating unit may analyze and classify the user's activity types, check a keyword category in various manners according to the classified user's activity types, select an entity name having the highest association degree to the checked keyword category, as a representative keyword, and generate and update an activity profile of the user through the representative keyword.

The network generating unit may generate the social network according to a social network generation request from the user.

The interest keyword inferring unit may check keywords stored in the user's activity profile and classify attributes of the keywords to thus infer a location and time interest keyword appropriate for time and space.

The interest keyword inferring unit may include: a checking unit configured to check the user profile; a collecting unit configured to collect information regarding a current location of the user; and an inferring unit configured to infer a location and time interest keyword among the current location information and the keywords stored in the user profile.

In classifying the user's activity types, the user's activity types may be classified into an activity of reading contents, an activity of leaving comments, and an activity of evaluating contents.

In another aspect, a system for providing a social network service through the user's social activities by automatically recognizing a user's social activities is provided. The system includes: a social network generating module configured to generate a user profile based on a user activity profile obtained by collecting and classifying the user's social activities and a user information profile, and generate a social network by analyzing a user interest level based on the user profile; and a data repository configured to store and manage data in relation to the social network by interworking with the social network generating module.

The data repository may include: a keyword ontology storage unit configured to define keywords and classification of the keywords and store the same; a user profile storage unit configured to store and update the user activity profile; and a social network storage unit configured to store the generated user social network in a standardized form.

### BRIEF DESCRIPTION OF THE DRAWINGS

FIG. 1 is a conceptual view of generating a social cloud by analyzing social activities in a method for providing a social network service using social activities according to an embodiment of the present invention.

FIG. 2 is a flow chart illustrating the method for providing a social network service using social activities according to an embodiment of the present invention.

FIG. 3 is a detailed flow chart illustrating a step of generating a profile in the method for providing a social network service using social activities according to an embodiment of the present invention.

FIG. 4 is a detailed flow chart illustrating a step of generating and updating a social activity profile by analyzing social activities in the step of generating a profile in the method for providing a social network service using social activities according to an embodiment of the present invention.

FIG. 5 is a detailed flow chart illustrating a step of generating a network in the method for providing a social network service using social activities according to an embodiment of the present invention.

FIG. 6 is a detailed flow chart illustrating a step of inferring an interested keyword in the method for providing a social network service using social activities according to an embodiment of the present invention.

FIG. 7 is a schematic block diagram of an apparatus for providing a social network service using social activities according to another embodiment of the present invention.

FIG. 8 is a detailed block diagram of a network generating unit of the apparatus for providing a social network service using social activities according to another embodiment of the present invention.

FIG. 9 is a detailed block diagram of an interest keyword inferring unit of the apparatus for providing a social network service using social activities according to another embodiment of the present invention.

FIG. 10 is a schematic block diagram of a system for providing a social network service using social activities according to another embodiment of the present invention.

### DESCRIPTION OF EXEMPLARY EMBODIMENTS

The present invention may be variably modified and have various embodiments, and particular embodiments will be illustrated in drawings and described in detail.

However, the present invention is not limited to the particular embodiments and the present invention should be construed as including all the changes, equivalents, and substitutions included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The terminology used herein is for the purpose of describing particular embodiments only and is not intended to be limiting of the invention. Singular forms “a”, “an” and “the” are intended to include the plural forms as well, unless the context clearly indicates otherwise. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein including technical or scientific terms have the same meaning as commonly understood by one of ordinary skill in the art to which this invention pertains, and should not be interpreted as having an excessively comprehensive meaning nor as having an excessively contracted meaning. If technical terms used herein fail to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

Embodiments of the present invention will be described below in detail with reference to the accompanying drawings, where those components are rendered the same reference number that are the same or are in correspondence, regardless of the figure number, and redundant explanations are omitted.

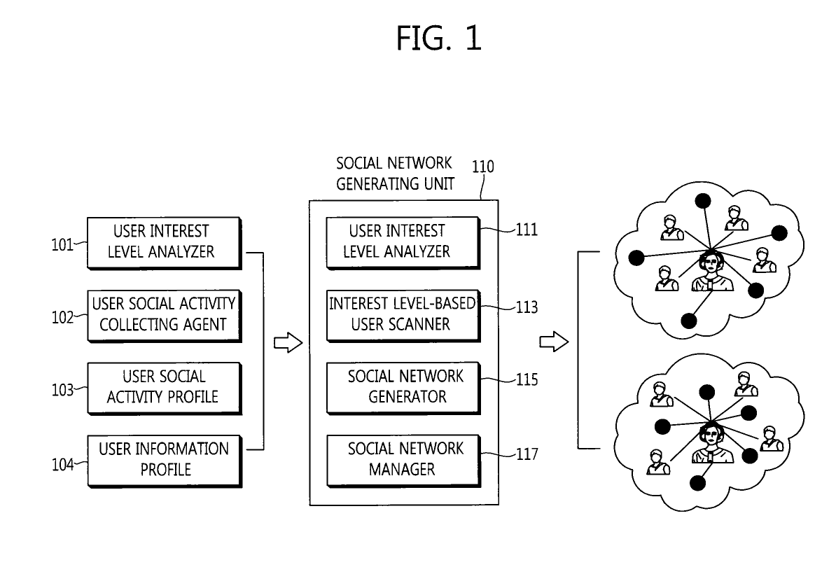

FIG. 1 is a conceptual view of generating a social cloud by analyzing social activities in a method for providing a social network service using social activities according to an embodiment of the present invention. As shown in FIG. 1, in the social network service providing method according to an embodiment of the present invention, user's social activities are collected and analyzed, the collected and analyzed user's social activities are profiled, and a social network is generated based on the profile.

In the method for providing a social network service (or the social network service providing method) according to an embodiment of the present invention, a user location information register 101, a user social activity collecting agent 102, a user social activity profile, and a user information profile may be used. Here, the user location register 101 may receive user location information from a user information terminal and register the same. The user social activity collecting agent 102 may collect and analyze user's social activities. A user social activity profile may be configured by using the collected user's social activities and user location information, and updated. Also, the user information profile 104 provides basic information regarding the user, rather than user's social activities. Here, the user information profile 104 may include a user's specific belonging, occupation, career, and the like, but the present invention is not limited thereto. A social network optimized for the user is generated based on the configured user profile.

The social network generating unit 110 generating a social network optimized for the user based on the profile may include a user interest level analyzer 111, an interest level-based user scanner 113, a social network generator 115, and a social network manager 117. The user interest level analyzer 111 analyzes a user's interest level with the user activity profile and the user information profile as described above. The user's interest level may be categorized into fields the user is interested in. The user scanner 113 searches a different user by matching the user interest level based on the user interest level analyzed by the user interest level analyzer 111. Here, the different user should have an interest level of the user through a user interest level analyzer. The social network generator 115 configures a social network with respect to the different user searched by the user scanner 113. The social network manager 117 continuously manages the social network generated by the social network generator 115 toward the future.

For example, when the user has actively performed searching and reading in relation to a particular keyword and left comments regarding relevant written comments online at usual times, an association degree of the user with keywords used for searching, reading, and leaving comments may be increased. This is reflected in the social activity profile. When the user wants to configure a social network related to himself, the user may request recommendation and generation of a social network from a system. The social network generating unit 110 may search a different user matched to the user's social activity profile and information profile and configure a time and space-based multi-aspect social network 120 based on the search result.

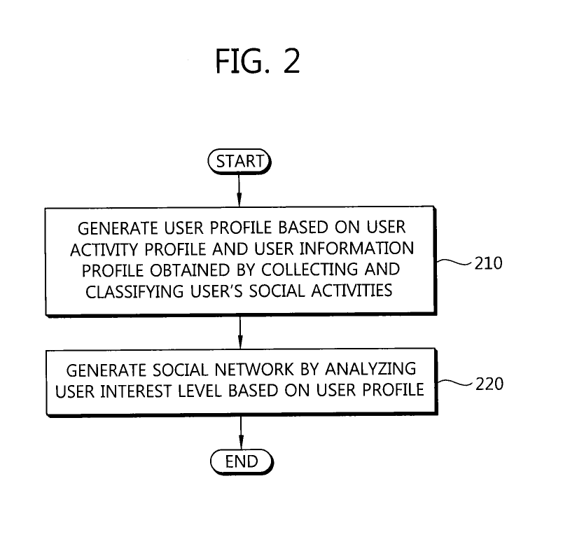

FIG. 2 is a flow chart illustrating the method for providing a social network service using social activities according to an embodiment of the present invention. As shown in FIG. 2, the method for providing a social network service using social activities may include a step (210) of generating a user profile based on a user activity profile and a user information profile obtained by collecting and classifying the user's social activities and a step (220) of analyzing a user's interest level based on the user profile to generate a social network.

In the profile generating step (210), a profile generating unit (not shown) collects the user's social activities to generate a user activity profile and combines the user activity profile with a user information profile to generate a user profile. First, the profile generating unit collects user's social activities. This is similar to the function of the user social activity collecting agent 102 of FIG. 1. The collected user's social activities are categorized according to the characteristics of respective activities so as to be classified. The category of activities may include an activity of reading contents, an activity of evaluating contents, an activity of leaving comments, and the like, but the present invention is not limited thereto. After the user's social activities are classified, the classified social activities are profiled to generate a user activity profile. In this case, the user's dynamic activities are profiled. The profile generating unit uses the user information profile 104 described above with reference to FIG. 1. The user activity profile and the user information profile are combined to finally generate a user profile.

In the network generating step (220), a network generating unit (not shown) analyzes a user's interest level based on the user profile generated in the profile generating step (210) to generate a social network. First, the network generating unit checks the user profile to analyze an interest level. Here, various methods may be used to analyze the interest level. For example, various analysis methods such as a frequency analysis of analyzing frequency with which the user has accessed a particular keyword by checking a social profile, a cross tabulation, an analysis of variance, a correlation analysis, and the like. Through this analyzing process, a representative keyword the user is interested in may be selected. Thereafter, a different user related to the representative keyword may be searched, and a social network may be generated based on the searched different user.

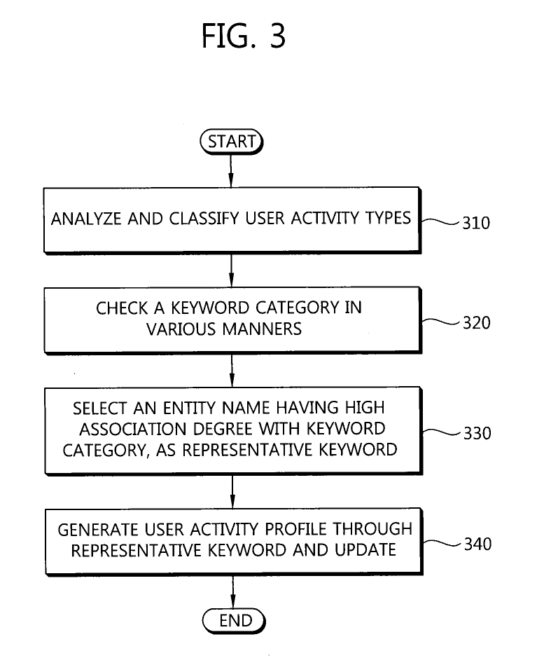

FIG. 3 is a detailed flow chart illustrating the step (210) of generating a profile in the method for providing a social network service using social activities according to an embodiment of the present invention. As shown in FIG. 3, the profile generating step (210) may include a step (310) of analyzing and classifying the user's activity types, a step (320) of checking a keyword category in various manners, a step of selecting an entity name having a high association degree with the keyword category, as a representative keyword, and a step (340) of generating and updating a user activity profile through the representative keyword.

First, in the user activity type analyzing and classifying step (310), the profile generating unit (not shown) analyzes the types of user's social activities and categorizes them. For example, when the user accesses a particular news article or a particular blog to read contents of the blog, the user activity may be classified into a content read category. Here, the activity type category may include reading contents, evaluating contents, and leaving comments.

Thereafter, in the keyword category checking step (320), the profile generating unit may determine entity names related to the user's social activities by employing various schemes according to categories classified according to the user's activity types and checks keyword categories. The profile generating unit checks the keyword categories through a keyword ontology included in a data repository. The keyword ontology includes keyword categories divided and categorized into particular keywords as large bundles and includes several words belonging to a corresponding keyword. Thus, the profile generating unit extracts a particular entity name from contents accessed by the user, and checks a keyword category matched to the extracted entity name.

In the representative keyword selecting step (330), the profile generating unit selects an entity name having the highest association degree with the keyword category checked in the keyword category checking step (320), as a representative keyword.

In the activity profile generating and updating step (340), the profile generating unit generates an activity profile of the user through the representative keyword selected in the representative keyword selecting step (330) and performs updating thereon. Updating may be performed whenever the user conducts social activities.

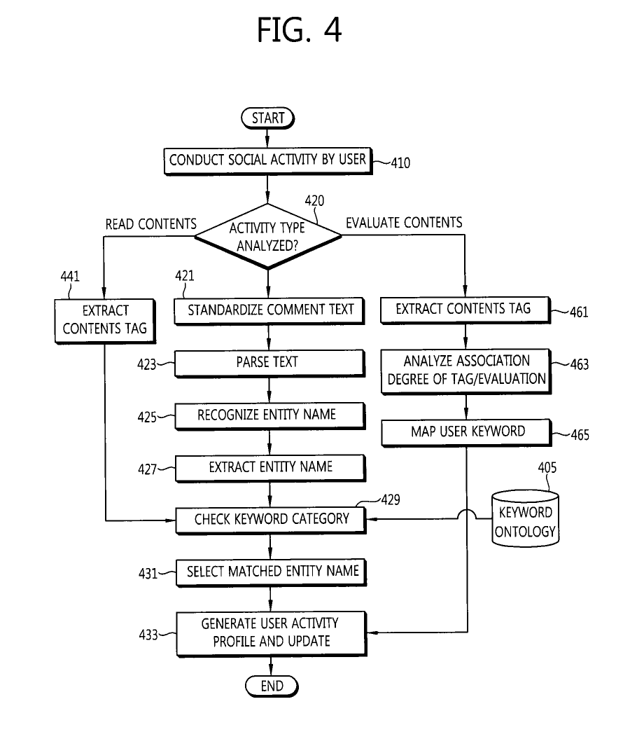

FIG. 4 is a detailed flow chart illustrating a step of generating and updating a social activity profile by analyzing social activities in step (210) of generating a profile in the method for providing a social network service using social activities according to an embodiment of the present invention.

First, when the user conducts social activities online (410), the profile generating unit (not shown) analyzes the user's social activities (420). The user's social activities may be classified into reading contents, leaving comments, and evaluating contents. Reading contents may refer to a user activity of searching an Internet article, an interest keyword, contents of a particular Internet community, or the like. Leaving comments refers to a user activity of leaving comments in regards to contents uploaded by a different user. Evaluating contents refers to a user activity of evaluating contents uploaded by a different user such as scoring particular contents, or the like.

When the user's social activity is leaving comments to particular contents, the comments created by the user are standardized into a text form (421). Thereafter, in order to analyze comments in a text form created by the user, the standardized text is parsed (423). There may be several entity names in the parsed text, and a particular entity name among them is compared with the repository so as to be recognized (425). Thereafter, the entity name recognized through the repository is extracted (427). The extracted entity name is recognized as a keyword, and a category classification with respect to this keyword is checked through the keyword ontology (405) (429). An entity name having the highest association degree among the categories with the checked keyword is selected as a representative keyword (431). An activity profile of the user is generated through the selected representative keyword, and the generated profile is continuously updated (433). For example, when the user creates comments for contents related to “Lotte Giants”, the created comments are analyzed to select a representative keyword through the foregoing sequential process, and an activity profile is generated and updated.

When the user's social activity is an activity of reading particular contents, a tag of the corresponding contents is extracted (441). A category in which the tag is included is checked through the keyword ontology (405). An entity name having the highest association degree with the checked category is selected as a representative keyword (431). As mentioned above, a user's activity profile is generated through the selected representative keyword, and the generated profile is continuously updated (433). For example, in case in which the user reads contents related to “Lotte Giants” online, when it is assumed that a corresponding contents tag is extracted and the tag is tagged as a “Lotte Giants” related word, a category checked through the keyword ontology (405) may be checked as “Professional baseball”. In this case, “Lotte Giants” and “Professional baseball” are stored in the user's activity profile, based on an activity profile that is generated and updated.

When the user's social activity is an activity of evaluating particular contents, a tag of target contents is extracted, like the case of reading contents (461). Thereafter, an association degree between a relevant tag and evaluation is analyzed (463). It is mapped to a user keyword (465) and immediately stored as a preference between a keyword and the user in the activity profile (433). For example, when the user gives a high score to the contents related to “Lotte Giants”, the user may classify “Lotte Giants” to have a highly preferred level. Thus, in this case, it may be considered that the user has high preference with respect to “Lotte Giants” and this disposition may be reflected in the user activity profile.

Through the foregoing sequential process, the user's social activities are continuously recorded in the activity profile and updated, and the corresponding contents may be used as a user's interest keyword in a network generating step hereinafter.

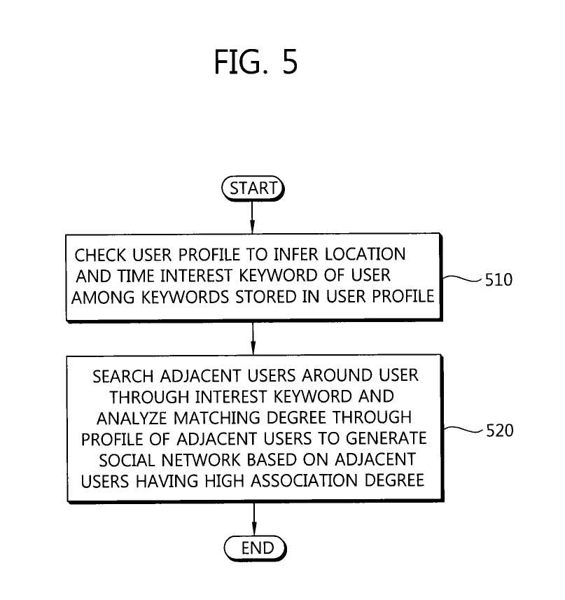

FIG. 5 is a detailed flow chart illustrating a step (220) of generating a network in the method for providing a social network service using social activities according to an embodiment of the present invention. As shown in FIG. 5, the network generating step (220) may include a step (510) of checking a user profile and inferring location and time interest keyword of a user among keywords stored in the user profile and a step (520) of searching adjacent users of the user through the interest keyword, analyzing activity matching degrees through activity profiles of the adjacent users, and generating a social network based on an adjacent user having a high association degree.

In the network generating step (220), in order to generate the social network, the user may request a social network by selecting a social activity base. A network generating unit (not shown) generates a social network upon receiving the user request.

First, in an interest keyword inferring step (510), the network generating unit checks the user profile generated in the profile generating step (210). The user profile includes a user activity profile and a user information profile. Each profile includes several keywords. Thus, the network generating unit infers a location interest keyword of the user including information regarding the user's current location and a time interest keyword related to time having a high interest level of the user among several keywords included in the user profile.

In the social network generating step (520), the network generating unit searches an adjacent user having the same interest as that of the user through the interest keyword inferred in the interest keyword inferring step (510) and analyzes an activity matching degree through an activity profile of the adjacent user to generate a social network based on the adjacent user having the high association degree. In order to search the adjacent user, the adjacent user is also required to have his activity profile. The network generating unit searches other users having the same interest keyword as that of the user who wants to generate a network, and checks an activity profile of each of the other users. The checked activity profiles of the other users are analyzed in accordance with the profile of the user who wants to generate a network to find the other users that have the highest matching degree. The high matching degree of the other users indicates that the other users are interested in matters similar to those of the user who wants to generate a network. By generating a social network based on other users, a social network optimized for the user can be generated, thus providing various network services.

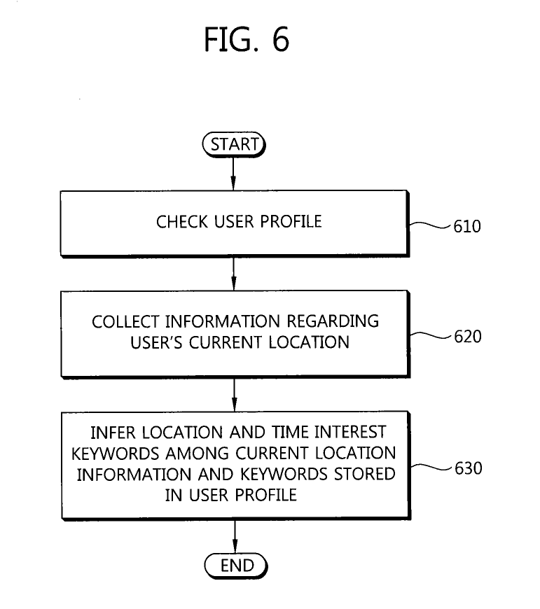

FIG. 6 is a detailed flow chart illustrating a step (510) of inferring an interested keyword in the method for providing a social network service using social activities according to an embodiment of the present invention. As shown in FIG. 6, the interest keyword inferring step (510) includes a user profile checking step (610), a user current location information collecting step (620), and a step (630) of inferring a location and time interest keyword among the current location information and keywords stored in the user profile (630).

In the user profile checking step (610), the profile generating unit (not shown) checks a social profile of the user. The checked profile is generated in the profile generating step (210) and includes preference with respect to a user's interest keyword, a category to which the keyword belongs, and a keyword input through a user's evaluation behavior based on the user's social activities conducted online.

In the current location information collecting step (620), the profile generating unit receives information regarding a current location of the user. The current location information may be received through a location-based system (LBS) including a GPS, a GNSS, a GIS, or the like, and to this end, wireless communication such as a 3G wireless Internet network, Wi-Fi, or the like, may be used.

In the location and time interest keyword inferring step (630), the profile generating unit obtains an interest keyword of a place and an interest keyword of time of the current user. The interest keywords are stored in a pre-defined database, and keywords related to a particular place and time are defined. For example, in the case of keyword “Insa-dong”, a database previously defined by the user such as an art museum, a gallery, good restaurant, and the like, is referred to. In relation to the time interest keyword, a method of checking association with an event which currently occurs among keywords stored in the user profile may be used. For example, in case in which the user has a high interest level with respect to “Lotte Giants”, when Lotte Giants included in a current professional baseball (event) schedule plays a game, the corresponding keyword is inferred as an interest keyword of a current time. The network generating unit is required to configure a social network by combining the keywords, and here, the network generating unit checks adjacent users of the current user and checks activity profiles of the adjacent users to analyze activity matching degrees. The network generating unit generates a social network based on users having high association degree through the analyzed matching degrees.

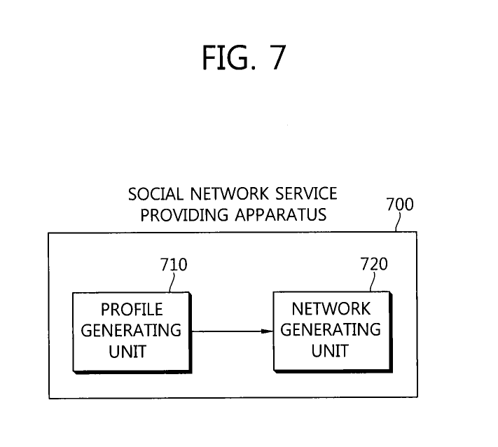

FIG. 7 is a schematic block diagram of an apparatus for providing a social network service using social activities according to another embodiment of the present invention. As shown in FIG. 7, an apparatus 700 for providing a social network service (or a social network service providing apparatus 700) may include a profile generating unit 710 and a network generating unit 720.

The profile generating unit 710 collects the user's social activities to generate a user activity profile, and combines the generated user activity profile with a user information profile to generate a user profile. First, the profile generating unit 710 categorizes the collected user's social activities according to the characteristic of the respective activities. The category of activities may include an activity of reading contents, an activity of evaluating contents, and an activity of leaving comments, but the present invention is not limited thereto. After the user's social activities are classified, the classified social activities are profiled to generate a user activity profile. In this case, user's dynamic activities are profiled. As mentioned above, based on a user information profile (not shown), the profile generating unit 710 combines the user activity profile and the user information profile to finally generate a user profile.

The profile generating unit 710 analyzes the types of the user's social activities to categorize them. For example, when the user accesses a particular news article or a particular blog to read contents of the blog, the user activity may be classified into a content read category. Here, the activity type category may include reading contents, evaluating contents, and leaving comments. Thereafter, the profile generating unit 710 may determine entity names related to the user's social activities by employing various schemes according to categories classified according to the user's activity types and checks keyword categories. Also, the profile generating unit 710 checks the keyword categories through a keyword ontology included in a data repository. The profile generating unit 710 extracts a particular entity name from contents accessed by the user, checks a keyword category matched to the extracted entity name, and selects an entity name having the highest association degree with the checked keyword category, as a representative keyword. Thereafter, the profile generating unit 710 generates an activity profile of the user through the selected representative keyword and performs updating thereon. Updating may be performed whenever the user conducts social activities.

In more detail, when the user conducts social activities online, the profile generating unit 710 analyzes the user's social activities. The user's social activities may be classified into reading contents, leaving comments, and evaluating contents. When the user's social activity is leaving comments to particular contents, the profile generating unit 710 standardizes the comments created by the user into a text form, and parses the standardized text in order to analyze the comments text created by the user. There may be several entity names in the parsed text, and the profile generating unit 710 compares a particular entity name among them with the repository to recognize it. Thereafter, the profile generating unit 710 extracts the entity name recognized through the repository. The extracted entity name is recognized as a keyword, and a category classification with respect to this keyword is checked through the keyword ontology. An entity name having the highest association degree among the checked keyword and category is selected as a representative keyword, an activity profile of the user is generated through the selected representative keyword, and the generated profile is continuously updated.

When the user's social activity is an activity of reading particular contents, the profile generating unit 710 extracts a tag of the corresponding contents. Thereafter, the profile generating unit 710 checks a category in which the tag is included, through the keyword ontology, and selects an entity name having the highest association degree with the checked category, as a representative keyword. The profile generating unit 710 generates a user's activity profile through the selected representative keyword, and continuously updates the generated profile.

When the user's social activity is an activity of evaluating particular contents, the profile generating unit 710 extracts a tag of target contents, like the case of reading contents. Thereafter, the profile generating unit 710 analyzes an association degree between a relevant tag and evaluation and maps it to a user keyword. The profile generating unit 710 recognizes the results obtained by analyzing the association degree of the tag and the evaluation as a preference between the keyword and the user, and immediately stores the same in the activity profile.

The network generating unit 720 analyzes the user's interest level based on the user profile generated by the profile generating unit 710 to generate a social network. The network generating unit 720 checks the user profile to analyze the user's interest level. The network generating unit 720 may analyze the user's interest level by using various analysis methods such as a frequency analysis of analyzing frequency with which the user has accessed a particular keyword, a cross tabulation, an analysis of variance, a correlation analysis, and the like, and select a representative keyword the user is interested in. The network generating unit 720 searches a different user in relation to the representative keyword and generates a social network based on the searched different user.

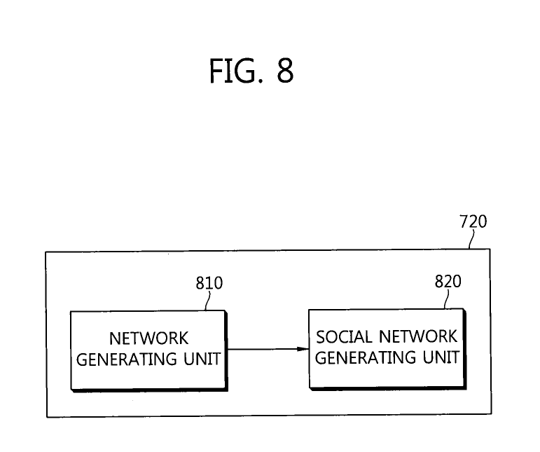

FIG. 8 is a detailed block diagram of a network generating unit of the apparatus for providing a social network service using social activities according to another embodiment of the present invention. As shown in FIG. 8, the network generating unit 720 may include an interest keyword inferring unit 810 and a social network generating unit 820.

In order to generate a network, the user may directly select a social activity base and request a network generation. The network generation unit 720 generates a social network upon receiving the user request.

The interest keyword inferring unit 810 checks a user profile generated in the profile generating unit 710. The user profile includes a user activity profile and a user information profile, and each profile includes several keywords. Thus, the interest keyword inferring unit 810 infers a location interest keyword of the user including information regarding the user's current location and a time interest keyword related to time having a high interest level of the user among several keywords included in the user profile.

The social network generating unit 820 searches an adjacent user having the same interest as that of the user through the interest keyword inferred by the interest keyword inferring unit 810 and analyzes an activity matching degree through an activity profile of the adjacent user to generate a social network based on the adjacent user having the high association degree. In order to search the adjacent user, the adjacent user is also required to have his activity profile. The social network generating unit 820 searches adjacent users having the same interest keyword as that of the user who wants to generate a network, checks an activity profile of each of the adjacent users, and analyzes the checked activity profiles of the adjacent users over the profile of the user who wants to generate a network to find out an adjacent user having the highest matching degree. The high matching degree of the adjacent user indicates that the adjacent user is interested in matters similar to those of the user who wants to generate a network, so, by generating a social network based on the adjacent user having a high matching degree, a social network optimized for the user can be generated.

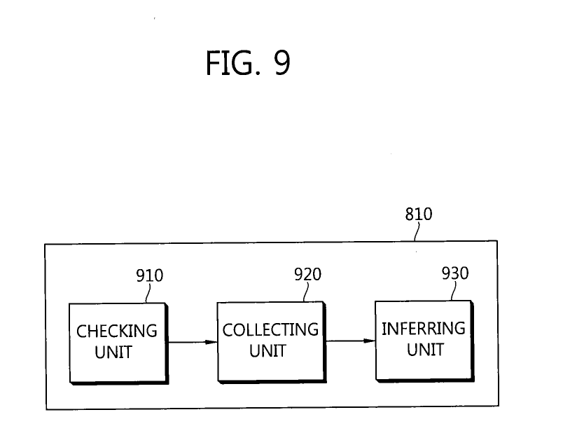

FIG. 9 is a detailed block diagram of the interest keyword inferring unit 810 of the apparatus for providing a social network service using social activities according to another embodiment of the present invention. As shown in FIG. 9, the interest keyword inferring unit 810 may include a checking unit 910, a collecting unit 920, and an inferring unit 930.

The checking unit 910 checks a social profile of the user. The checked profile is generated by the profile generating unit 710 and includes preference with respect to a user's interest keyword, a category to which the keyword belongs, and a keyword input through the user's evaluation behavior based on the user's social activities conducted online.

The collecting unit 920 receives information regarding a current location of the user. As mentioned above, the collecting unit 920 may receive the current location information through a location-based system (LBS) including a GPS, a GNSS, a GIS, or the like, and to this end, a wireless communication scheme such as a 3G wireless Internet network, Wi-Fi, or the like, may be used.

The inferring unit 930 obtains an interest keyword of a place and an interest keyword of time of the current user. The interest keywords are stored in a pre-defined database, and keywords related to a particular place and time are defined. In relation to the location interest keyword, the inferring unit 930 may consider the user's current location collected by the collecting unit 920. In relation to the time interest keyword, a method of checking a connection between a keyword among keywords stored in the user profile and a current event may be used.

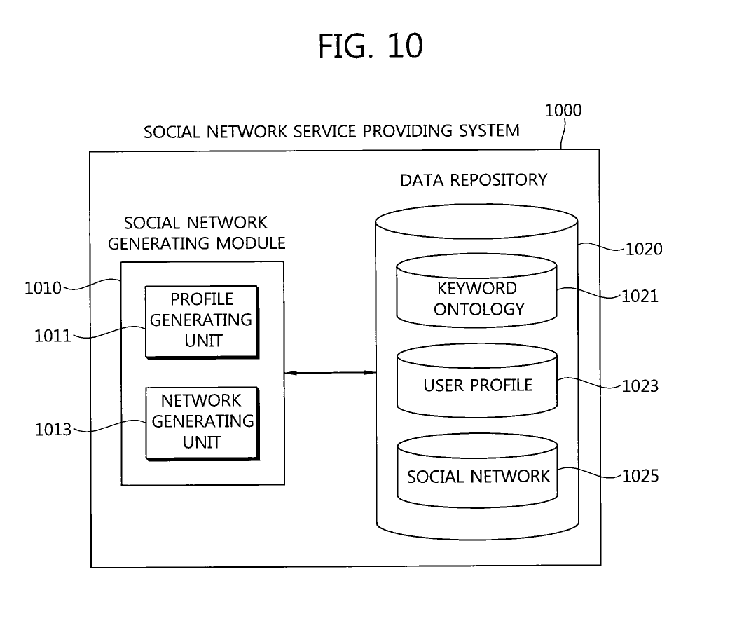

FIG. 10 is a schematic block diagram of a system 1000 for providing a social network service using social activities according to another embodiment of the present invention. As shown in FIG. 10, the system 1000 for providing a social network service (or a social network service providing system 1000) according to an embodiment of the present invention may include a social network generating module 1010 for processing data and generating a social network and a data repository 1020 for storing data.

The social network generating module 1010 automatically recognizes a user's social activities to generate a social network. The social network generating module 1010 may include a profile generating unit 1011 and a network generating unit 1013. The profile generating unit 1011 generates a user profile based on a user activity profile obtained by collecting the user's social activities and a user information profile. Here, a process of checking keywords, managing the attributes and classification of the keywords, and inferring a keyword appropriate for a time and space may be included. The network generating unit 1013 may load and extract the user profile to configure a social network fitting respective interest levels.

The data repository 1020 is a device interworking with the social network generating module 1010. The data repository 1020, as a storage unit for storing and managing data during the foregoing sequential process, includes a keyword ontology storage unit 1021, a user profile storage unit 1023, and a social network storage unit 1025. The keyword ontology storage unit 1021 may define and store keywords and classification of the keywords. The user profile storage unit 1023 stores the user activity profile and data for updating the user activity profile. The social network storage unit 1025 stores the generated user social network in a standardized form.

According to the social network service providing method, apparatus, and system of the present invention, in order to provide a social network service, a user's activities are collected and analyzed to configure a multi-aspect social network fitting a time and space based on the collected and analyzed user activities.

Also, according to the social network service providing method, apparatus, and system of the present invention, a service for providing a customized social network most appropriate for a time and space to a user can be provided.

In addition, the social network service providing method, apparatus, and system of the present invention can be applicable to a specialist recommendation group providing service and a user recommendation service according to social activities, and in particular, a user can establish a knowledge-sharing infrastructure with a reliable social network group through social activities.

While the present invention has been shown and described in connection with the embodiments, it will be apparent to those skilled in the art that modifications and variations can be made without departing from the spirit and scope of the invention as defined by the appended claims.

What is claimed is:

1. A method for providing a social network service through a user's social activities by automatically recognizing the user's social activities, the method comprising:
a profile generating step of generating a user profile based on a user activity profile obtained by collecting and classifying the user's social activities and a user information profile; and
a network generating step of generating a social network by analyzing a user interest level based on the user profile.

2. The method of claim 1, wherein the network generating step includes:
an interest keyword inferring step of inferring a location and time interest keyword of the user among keywords stored in the user profile by checking the user profile; and
a social network generating step of searching other users having the same interest as that of the user through the interest keyword, and analyzing activity matching degrees through activity profiles of the other users to generate a social network based on other users having a high association degree.

3. The method of claim 2, wherein, in the user profile generating step, the user's activity types are analyzed and classified, a keyword category is checked in various manners according to the classified user's activity types, an entity name having the highest association degree to the checked keyword category is selected as a representative keyword, and an activity profile of the user is generated and updated through the representative keyword.

4. The method of claim 1, wherein the network generating step is performed according to a social network generation request from the user.

5. The method of claim 2, wherein, in the interest keyword inferring step, keywords stored in the user's activity profile are checked and attributes of the stored keywords are classified to thus infer a location and time interest keyword appropriate for time and space.

6. The method of claim 2, wherein the interest keyword inferring step includes:
checking the user profile;
collecting information regarding a current location of the user; and
inferring a location and time interest keyword among the current location information and the keywords stored in the user profile.

7. The method of claim 3, wherein, in classifying the user's activity types, the user's activity types are classified into an activity of reading contents, an activity of leaving comments, and an activity of evaluating contents.

8. An apparatus for providing a social network service through the user's social activities by automatically recognizing the user's social activities, the apparatus comprising:
a profile generating unit configured to generate a user profile based on a user activity profile obtained by collecting and classifying the user's social activities and a user information profile; and
a network generating unit configured to generate a social network by analyzing a user interest level based on the user profile.

9. The apparatus of claim 8, wherein the network generating unit includes:
an interest keyword inferring unit of inferring a location and time interest keyword of the user among keywords stored in the user profile by checking the user profile; and
a social network generating unit of searching adjacent users having the same interest as that of the user through the interest keyword, and analyzing activity matching degrees through activity profiles of the adjacent users to generate a social network based on an adjacent user having a high association degree.

10. The apparatus of claim 8, wherein the user profile generating unit analyzes and classifies the user's activity types, checks a keyword category in various manners according to the classified user's activity types, selects an entity name having the highest association degree to the checked keyword category, as a representative keyword, and generates and update an activity profile of the user through the representative keyword.

11. The apparatus of claim 8, wherein the network generating unit generates the social network according to a social network generation request from the user.

12. The apparatus of claim 9, wherein the interest keyword inferring unit checks keywords stored in the user's activity profile and classifies attributes of the keywords to thus infer a location and time interest keyword appropriate for time and space.

13. The apparatus of claim 9, wherein the interest keyword inferring unit includes:
a checking unit configured to check the user profile;
a collecting unit configured to collect information regarding a current location of the user; and
an inferring unit configured to infer a location and time interest keyword among the current location information and the keywords stored in the user profile.

14. The apparatus of claim 10, wherein, in classifying the user's activity types, the user's activity types are classified into an activity of reading contents, an activity of leaving comments, and an activity of evaluating contents.

15. A system for providing a social network service through the user's social activities by automatically recognizing the user's social activities, the system comprising:
a social network generating module configured to generate a user profile based on a user activity profile obtained by collecting and classifying the user's social activities and a user information profile, and generate a social network by analyzing a user interest level based on the user profile; and
a data repository configured to store and manage data in relation to the social network by interworking with the social network generating module.

16. The system of claim 15, wherein the data repository includes:
a keyword ontology storage unit configured to define keywords and classification of the keywords and store the same;
a user profile storage unit configured to store and update the user activity profile; and
a social network storage unit configured to store the generated user social network in a standardized form.
